(19) United States
(12) Patent Application Publication
(10) Pub. No.: US 2018/0249642 A1
(43) Pub. Date: Sep. 6, 2018

(54) METHOD AND APPARATUS BASED ON LASER FOR PROVIDING HIGH GROWTH, HIGH DENSITY PLANTATION SYSTEM

(71) Applicants: Lun Huang, San Diego, CA (US); Fei Huang, San Diego, CA (US)

(72) Inventors: Lun Huang, San Diego, CA (US); Fei Huang, San Diego, CA (US)

(21) Appl. No.: 15/451,170

(22) Filed: Mar. 6, 2017

(51) Int. Cl. A01G 7/04; F21V 23/04; F21V 5/00; A01G 31/00

(52) U.S. Cl. CPC A01G 7/045; F21V 23/0471; F21Y 2115/30; A01G 31/00; F21V 5/007

(57) ABSTRACT

A plantation growth lighting system comprised of laser diode (LD) array and automatic control unit is disclosed herein. The lighting system of the present invention is used for multi-layer hydroponic or soil-based plantation growth facilities to substantially improve the intensity of light. Since the light can be controlled to only distribute over the plants, the energy efficiency and the light intensity control of the present invention will be much better than the conventional lighting system in plantation growth facilities. As a result, the plurality of vegetal species will grow well with higher density within/without a closed environment.

### FIELD OF DISCLOSURE

The present disclosure related generally to plantation growth facilities or system that provides high growth, high density within or without a closure environment by using laser diode.

### BACKGROUND

### 1. Field of the Invention

The present invention is in the technical field of plantation growth lighting system. But the scope is not limited to this field. The present invention pertains to the field of lighting system providing specified light intensity in the most energy-efficient way.

### 2. Discussion of Related Art

The amount of farming land for conventional agriculture keeps going down due to the fact that ever-increasing population takes up more and more lands. On the other hand, the conventional agriculture requires large amount of water for irrigation, which turns out to be very inefficient. The plurality of irrigation water goes into open air via vaporization and expiration of plant with little contribution to the plant growth.

To enhance the utilization of limited resource of land and water, the high-density close-environment plantation growth facility is proposed to replace the conventional farm. However, the artificial lighting system thereof is not satisfactory solution for plant growth. The conventional lighting systems normally consist of non-unidirectional and unconcentrated light source, such as fluorescent light and light emission diode (LED). They can only support plantations that don't need high intensity of light. This substantially confines the application scope of artificial plantation growth facility. Additionally, a large portion of light that goes out of the area of plant is simply wasted, thus the energy efficiency is low.

Another issue with conventional lighting systems is that the light source is normally very close to the target plant to obtain higher intensity of light. For large-size plant, which covers a wide range of height, it is expensive and unrealistic with conventional lighting systems.

The present invention solves these problems in a novel and reliable way.

In order to ensure the absolute safety of the laser lighting system and comply with FCC rules, this system may further comprising an automatic detect system wherein sensors and algorithm can detect the proximity of human or pet nearby the system.

### BRIEF DESCRIPTION OF THE FIGURES

To explain and illustrate the advantages and characters of the present invention, figures are given as follows,

FIG. 1 is a schematic showing the laser diode array of the present invention;

FIG. 2 is a schematic showing the end view of the plantation growth lighting system;

FIG. 3 is a schematic showing the side view of the plantation growth lighting system;

FIG. 4 describes a timing scheme of the automatic control unit.

FIG. 5 describes a sensor scheme of the automatic control lighting system

FIG. 6 is a schematic showing the laser diode array implemented with laser diode and light-splitting device.

### REFERENCE

10 Red laser-diode
11 Blue laser-diode
12 Laser diode array
13 Group I
14 Stage 2
15 Group II
16 Laser-diode lighting module housing base
17 Heat sink and cooling fixture
18 Automatic control unit
19 Laser-diode lighting module power input-anode
20 Laser-diode lighting module power input-cathode
21 Power supply anode
22 Laser-diode array
23 Power-supply cathode
24 Vertical connection arm
25 On duration
26 Off duration
27 Group III
28 Light-splitting device

### DETAILED DESCRIPTION

The present invention describes an artificial plantation growth lighting system comprised of laser diode (LD) array and automatic control unit. This lighting system of the present invention is not only able to provide high-intensity illumination with little influence by the distance between lighting source and target plants, but also capable of controlling the light to only distribute over the plants to improve the energy efficiency. The scope of the present invention is defined by the appended claims and detailed description of a preferred embodiment instead of the statements within this summary.

The plantation growth lighting system as described in one embodiment of the present invention comprises: a laser-diode lighting module housing with installation base and the lighting module. The housing structure has vertical connection arms, which get notches connected to anode and cathode of power supply. The lighting module comprises one heat sink and cooling fixture, a laser-diode array, and an automatic control unit, wherein the sink and cooling fixture slidably connects to the anode and cathode of power supply with tenon bars.

In one aspect, the sink and cooling fixture further includes electrical fans to improve the air flow around the lighting module to enhance heat dissipation.

In low-power embodiment, the heat dissipation is low, the heat sink and cooling fixture is not necessary, the laser-diode array and the automatic control unit can be fixed on the same plane.

In another embodiment, the present invention provides a method of promoting the coloration and taste of plantation by replacing multitude of the blue and red laser diodes with ultra-violet (UV) and deep-red (far-red) laser diodes.

It should be understood that the scope of the present invention is not limited by the embodiments discussed below, which is intended for illustration of specific ways to implement or utilize the invention.

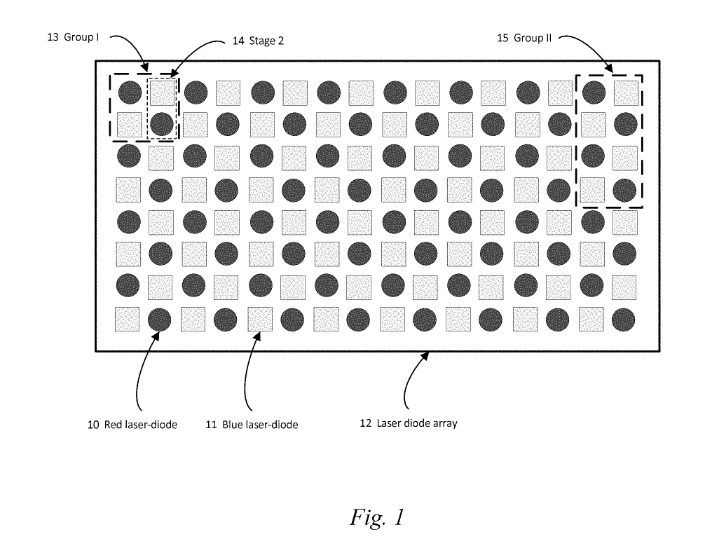

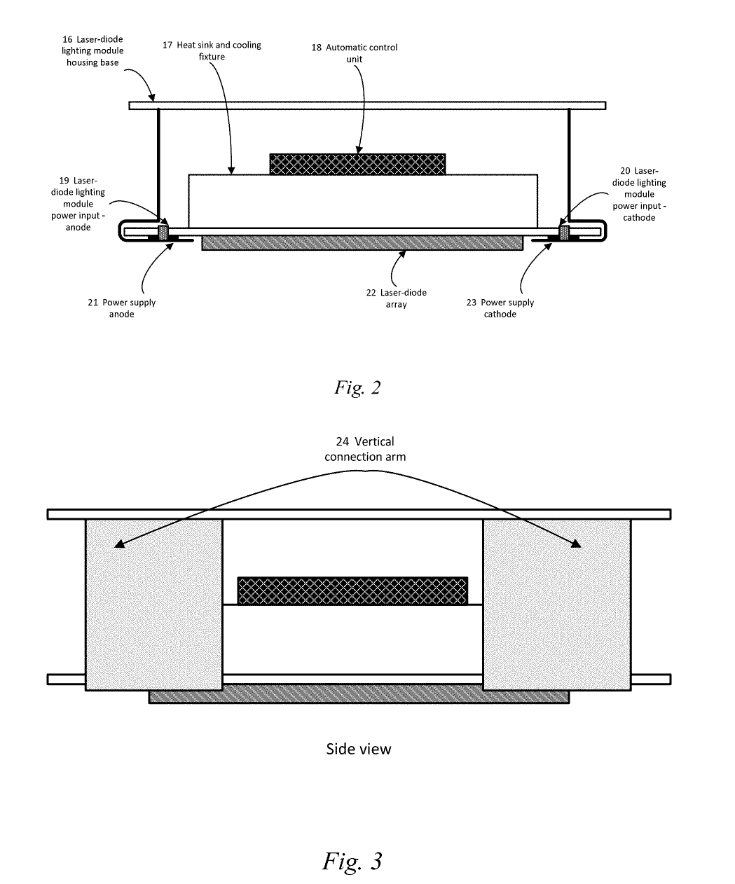

FIG. 1 shows the laser diode array in the present invention. The diodes in laser diode array are divided into groups to be operated by the automatic control unit. Group I and group II give two types of classification of laser diodes. One or more classification methods can be used in one laser diode array. Additionally, only the groups distributed over plantations are used, so that the lighting only covers the area of plantation and the energy efficiency is boosted.

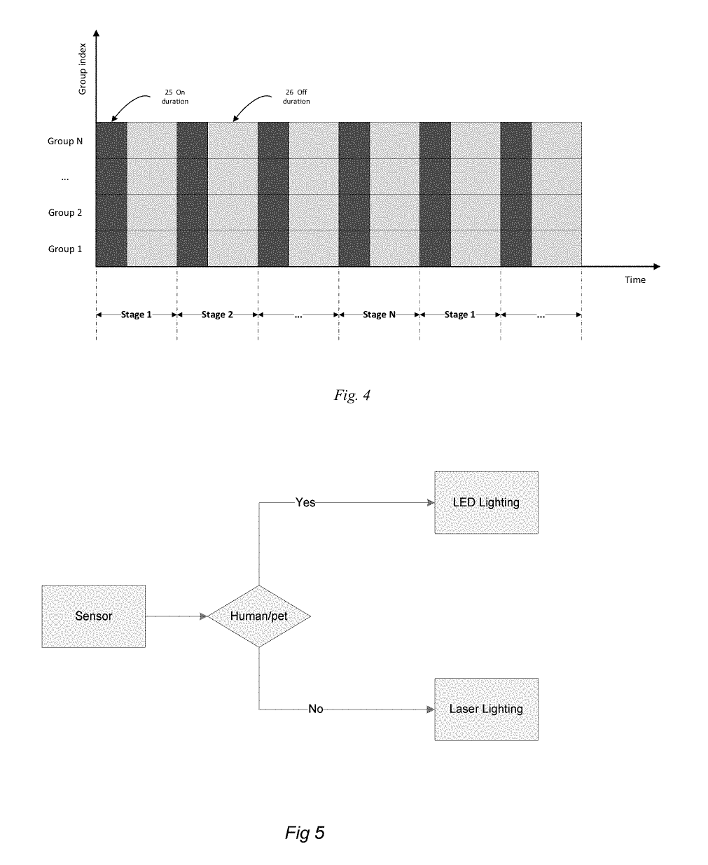

Stage is a subset of the group, which consists of one or more laser diodes. Each stage occupies one timing slot respectively. FIG. 4 shows one timing scheme used by the automatic control unit. The duty cycle is defined by the on and off durations of the stage. With different combination of on and off durations, the lighting intensity can be adjusted to arbitrary value.

The lighting intensity can also be controlled by introducing power control unit, which is capable of managing the output power and the intensity of light via adjusting the voltage and current of the laser diode. With optimum voltage and current settings, the laser diode can have longer life span and better energy efficiency by using the power control unit.

Although red (620-660 nm) and blue (430-485 nm) laser can support the growth of most plantations, it would be helpful for their health to further include laser with other wave-length in the range of 100-1000 nm. The present invention is very flexible with respect to introducing laser diode with arbitrary wave-length, e.g. UV (200-430 nm), green (500-565 nm), yellow/orange (580-610 nm) by substituting multitude of the blue and red laser diodes.

The ratio between the number of blue and red laser diodes can be easily adjusted. The distribution pattern of laser diodes in each group can also be designed respectively to adapt to different type of plantations. The blue and red laser diodes can be replaced with any kind of laser generator that produces mixture of lasers covering a range of wavelength, for example, white laser, which is the mixture of red, green and blue lasers.

Unlike conventional lighting system, the distance between light source and the target plantation does not obviously affect the performance of the present invention in providing sufficient intensity of light. This feature enables the present invention to economically offer lighting to support the growth of large-size plantation. The installation base of laser-diode lighting module housing is designed to fix to the supporting frame of plantation growth facility, such as the multi-layered grow rack structure, or the ceiling of building room, or any surface to install the lighting system for plantation growth.

FIG. 5 shows the operation flow chart of a proximity detect system that will switch lighting source when human or pet that is nearby, the proximity detects system additionally comprising one or more sensors for detection on one or more sides of the apparatus, wherein attaching a mean for controlling the activation of light source based upon the sensors detects result.

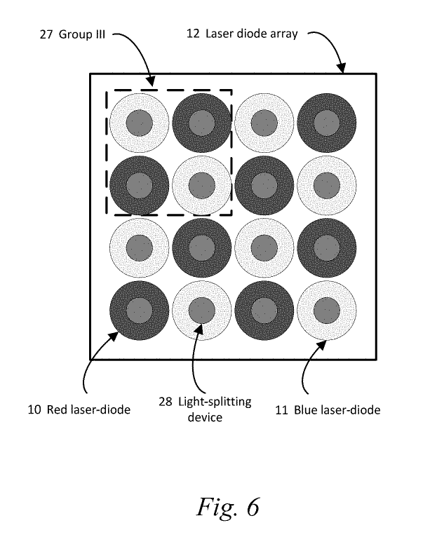

FIG. 6 shows another embodiment of the current invention. The laser diode array is implemented with laser diode and light-splitting devices. The laser diode thereof can be high-power and the intensity of direct output of laser is very high. The light-splitting devices, e.g. laser refraction beam head, are used to split the original high-intensity laser beam into multitude of light beams with intensity in the acceptable range for plants.

The laser diode array can also be replaced with laser generator and optical fibers. The laser generator can be arbitrary kind, including chemical laser generator and solid-state laser generator. In this embodiment, the laser generator thereof can be high-power, and the light-splitting devices can be used before and after optical fibers to split the original high-intensity laser beam into multitude of light beams with intensity in the acceptable range for plants.

In the similar way, the laser diode array can also be substituted with arbitrary optical devices that use laser as light source to provide lighting for plantations. These optical devices, e.g. mirror, may reflect, refract or split the original laser beam to generate multitude of laser beams or light with intensity in the acceptable range for plants.

We claim:

1. A plantation growth lighting system comprised of laser diode (LD) array and automatic control unit.

2. The laser diode lighting system of the present invention is used for multi-layer hydroponic or soil-based plantation growth facilities to substantially improve the intensity of light.

3. The method of claim 1 could be used within or without closed environment.

4. The method of claim 1 could be used for higher density of plantation due to full control of laser diode array that we are using.

5. The method of claim 1 have higher energy efficiency for lighting which lead to less heat emit to the system

6. The method of claim 5 could lead to that the transpiration of plantation is reduced and less water is evaporated into the air. AS a result, water consumption is lowered.

7. The method of claim 1 further comprising: a auto detect system that can find any human or pet's proximity to the system, it thereby can switch to other light source to prevent any possible harm.

8. The laser diode array of claim 1 can be implemented with high-power laser diode and light-splitting devices, such as refraction beam head for laser.

9. The laser diode array of claim 1 can be replaced with high-power laser generator (further including all kind of laser generators, such as chemical laser generator and solid-state laser generator) and optical fibers.

10. The method of claim 1 covers all embodiments that use laser as light source to provide lighting for plantations. These optical devices, e.g. mirror, may reflect, refract or split the original laser beam to generate multitude of laser beams or light with intensity in the acceptable range for plants.
